(19) United States
(12) Patent Application Publication
(10) Pub. No.: US 2014/0135075 A1
(43) Pub. Date: May 15, 2014

(54) PORTABLE DEVICE AND METHOD OF OUTPUTTING NOTIFICATION SOUND

(71) Applicant: Yasushi Kobayashi, Kanagawa (JP)

(72) Inventor: Yasushi Kobayashi, Kanagawa (JP)

(73) Assignee: NEC CASIO MOBILE COMMUNICATIONS, LTD., Kanagawa (JP)

(21) Appl. No.: 14/130,348

(22) PCT Filed: Jun. 11, 2012
(86) PCT No.: PCT/JP2012/003794

§ 371 Date: Dec. 31, 2013

(30) Foreign Application Priority Data
Jul. 11, 2011 (JP) 2011-152616

(51) Int. Cl. H04M 19/04

(52) U.S. Cl. CPC H04M 19/04
USPC 455/567

(57) ABSTRACT

A portable device includes plural parametric speakers that each output a sound having directivity in an individual specific direction; an attitude detecting unit that detects an attitude of the portable device; and a selecting unit that selects, from among the plural parametric speakers, a parametric speaker that outputs a sound having directivity whose direction falls within a predetermined range of an angle relative to a predetermined direction, on the basis of information on the attitude detected by the attitude detecting unit, and causes only the selected parametric speaker to output a predetermined notification sound.

### TECHNICAL FIELD

The present invention relates to a technique of outputting a notification sound in a portable device.

### BACKGROUND ART

Users of mobile phones set a desired incoming-call notifying manner to their mobile phones, for example, according to locations where they use their mobile phones. For example, a favorite incoming tone or music is used in general mode, and a vibrator is used when in silent mode.

However, the sounds or voices set for the incoming-call notification are outputted from a speaker provided to the mobile phone, which may annoy surrounding people. If the volume of the outputted sound is lowered to avoid this annoyance, it is highly possible that the user is not aware of the incoming-call notification. Further, if the vibrator is used, there is a possibility that the user is not aware of its vibration. If the user is not aware of the incoming-call notification, the user cannot answer it even if the user carries the phone. To address these problems, the following methods are proposed in the following documents.

### RELATED DOCUMENT

### Patent Document

Patent Document 1: Japanese Patent Application Laid-open No. H10-308980
Patent Document 2: Japanese Patent Application Laid-open No. 2007-96861
Patent Document 3: Japanese Patent Application Laid-open No. 2000-152323
Patent Document 4: Japanese Patent Application Laid-open No. H11-275183
Patent Document 5: Japanese Patent Application Laid-open No. 2008-035429
Patent Document 6: Japanese Patent Application Laid-open No. 2008-047947

### SUMMARY OF THE INVENTION

Each of the methods of notifying incoming calls described above has the following problems.

For example, although the incoming-call notification through the vibrator is less likely to annoy the surrounding people, this is the contact-type notification, and hence, the user is more likely to be unaware of the notification depending on individual differences or contacting states between the terminal and the user. With the conventional incoming-call notification using the speaker, the sound reaches the surrounding people as described above, and this may annoy them.

Incidentally, as for the speaker, there exists a high-directivity speaker called a parametric speaker. The parametric speaker is a type of ultrasonic wave speaker that has a sharp directivity in a specific direction. Thus, by designing the mobile phone so as to have this parametric speaker, it can be considered that the sound of the incoming-call notification is less likely to leak to the surroundings. However, in the case where this mode (including the parametric speaker) is employed, the sound may not reach the user depending on the directions of the parametric speaker's directivity.

The present invention has been made in view of the circumstances as described above, and provides a technique of outputting the notification sound in the portable device in a manner that reliably makes the user recognize the notification sound without annoying others.

Each mode of the present invention employs the following configurations to solve the problems described above.

The first aspect relates to a portable device. The portable device according to the first aspect includes plural parametric speakers that each output a sound having directivity in an individual specific direction; an attitude detecting unit that detects an attitude of the portable device; and a selecting unit that selects, from among the plural parametric speakers, a parametric speaker that outputs a sound having directivity whose direction falls within a predetermined range of an angle relative to a predetermined direction on the basis of information on the attitude detected by the attitude detecting unit, and causes only the selected parametric speaker to output a predetermined notification sound.

The second aspect relates to a method of outputting a notification sound performed by a portable device including plural parametric speakers that each output a sound having directivity in an individual specific direction. The method of outputting a notification sound according to the second aspect includes: detecting an attitude of the portable device; selecting, from among the plural parametric speakers, a parametric speaker that outputs a sound having directivity whose direction falls within a predetermined range of an angle relative to a predetermined direction on the basis of information on the detected attitude; and causing only the selected parametric speaker to output a predetermined notification sound.

The third aspect relates to a program performed by a portable device including plural parametric speakers that each output a sound having directivity in an individual specific direction. The program according to the third aspect causes the portable device to perform the following: detecting an attitude of the portable device; selecting, from among the plural parametric speakers, a parametric speaker that outputs a sound having directivity whose direction falls within a predetermined range of an angle relative to a predetermined direction on the basis of information on the detected attitude; and causing only the selected parametric speaker to output a predetermined notification sound.

It should be noted that another aspect according to the present invention may include a computer-readable recording medium that records the program according to the third aspect described above. This recording medium includes a non-transitory tangible medium.

According to each of the aspects described above, it is possible to provide a technique of outputting the notification sound in the portable device that reliably makes the user recognize the notification sound without annoying the others.

### BRIEF DESCRIPTION OF THE DRAWINGS

The above-described object and other objects of the present invention, and features and advantages of the present invention will be made further clear by the preferred embodiment described below and the following drawings attached thereto.

FIG. 1 is a schematic view illustrating an example of a configuration of a mobile phone device according to this exemplary embodiment.

FIG. 2 is a schematic view illustrating a relationship between the mobile phone device according to this exemplary embodiment and directivity of sounds outputted by parametric speakers.

FIG. 3 is a flowchart showing an example of operations performed by the mobile phone device according to this exemplary embodiment.

FIG. 4 is a diagram illustrating a first example of a usage mode of the mobile phone device according to this exemplary embodiment.

FIG. 5 is a diagram illustrating a second example of a usage mode of the mobile phone device according to this exemplary embodiment.

FIG. 6 is a diagram illustrating a third example of a usage mode of the mobile phone device according to this exemplary embodiment.

### DESCRIPTION OF EMBODIMENTS

Hereinbelow, exemplary embodiments according to the present invention will be described. Note that the exemplary embodiments described below are merely examples, and the present invention is not limited to the configurations of the exemplary embodiments

### [Device Configuration]

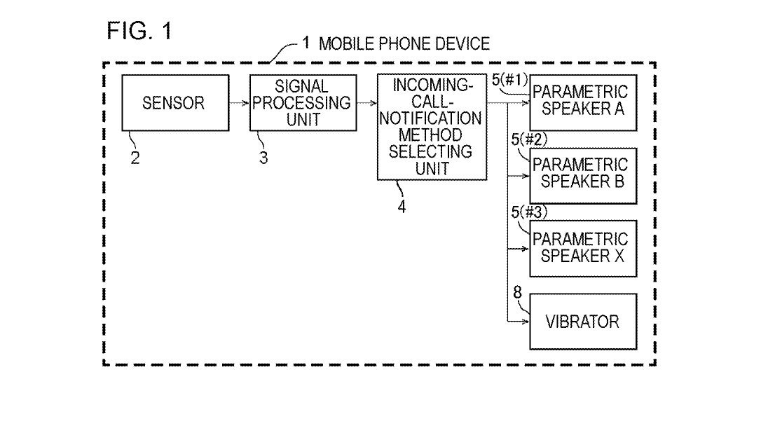

FIG. 1 is a schematic view illustrating an example of a configuration of a mobile phone device 1 according to this exemplary embodiment. As illustrated in FIG. 1, the mobile phone device 1 according to this exemplary embodiment includes, for example, a sensor 2, a signal processing unit 3, an incoming-call-notification method selecting unit 4 (hereinafter, also simply referred to as a selecting unit), plural parametric speakers 5 (#1), (#2), and (#3), and so on. Each of the signal processing unit 3 and the selecting unit 4 is realized by a hardware configuration element, a software configuration element, or a combination thereof. The hardware configuration element represents, for example, a hardware circuit such as a field programmable gate array (FPGA), an application-specific integrated circuit (ASIC), and a signal processing circuit. The software configuration element represents a software component (element) such as a task, a process, and a function realized with one or more processors (for example, a central processing unit (CPU) and a digital signal processor (DSP)) executing data (program) on one or more memories.

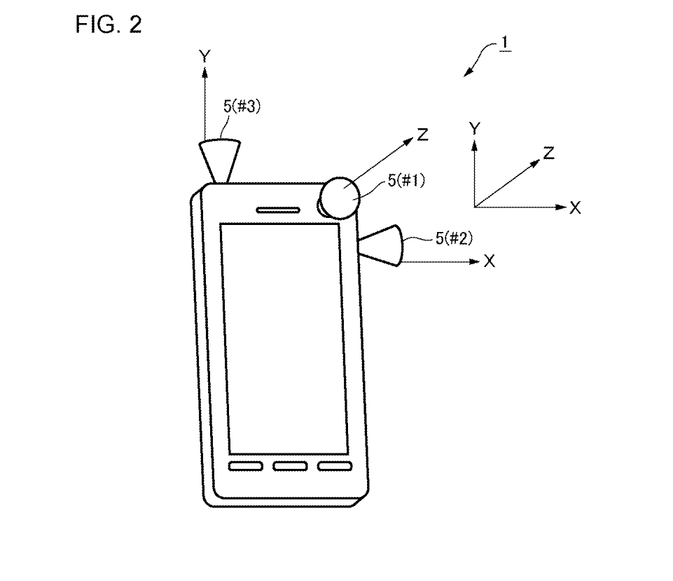

The parametric speakers 5 (#1), (#2), and (#3) each output a sound having directivity in an individual specific direction. FIG. 2 is a schematic view illustrating a relationship between the mobile phone device 1 according to this exemplary embodiment and the directivity of the sounds outputted by the parametric speakers 5. As illustrated in FIG. 2, the parametric speaker 5 (#1) outputs the sound having directivity in Z direction. The parametric speaker 5 (#2) outputs the sound having directivity in X direction. The parametric speaker 5 (#3) outputs the sound having directivity in Y direction. The X direction, the Y direction, and the Z direction illustrated in FIG. 2 are directions relative to a standard attitude of the mobile phone device 1, and are relative directions that vary according to attitudes of the mobile phone device 1. Note that FIG. 1 and FIG. 2 illustrate examples in which three parametric speakers 5 (#1), (#2), and (#3) are provided in the mobile phone device 1. However, it is only necessary that the number of the parametric speakers 5 is plural (two or more), and there is no limitation on the number of the parametric speakers 5.

The vibrator 8 vibrates the body of the mobile phone device 1.

The sensor 2 senses the attitudes of the mobile phone device 1. The sensor 2 is, for example, an earth-axis sensor. Note that, in this exemplary embodiment, there is no limitation on how the sensor 2 is realized, provided that the attitude of the mobile phone device 1 is sensed. Thus, the sensor 2 may be a combination of an acceleration sensor, a magnetic sensor and the like.

The signal processing unit 3 analyzes detected signals from the sensor 2, and generates attitude information indicating an attitude of the mobile phone device 1. This attitude information indicates an orientation of the mobile phone device 1, and the direction indicated by this attitude information indicates the absolute direction. The sensor 2 and the signal processing unit 3 correspond to an attitude detecting unit according to the present invention.

The selecting unit 4 selects a method of notifying incoming call in accordance with the attitude information generated by the signal processing unit 3. As illustrated in FIG. 1, the mobile phone device 1 according to this exemplary embodiment is provided with a method of outputting a desired notification sound from at least one of the plural parametric speakers 5, and a method of vibrating the vibrator 8. The selecting unit 4 switches these two methods, and changes parametric speakers 5 to output the notification sound in the case of the former method.

More specifically, the selecting unit 4 processes in the following manner. First, the selecting unit 4 calculates the direction of the directivity of the sound outputted from each of the parametric speakers 5 (#1), (#2), and (#3) on the basis of the attitude information (information on direction) concerning the mobile phone device 1 and transmitted from the signal processing unit 3. Hereinafter, the direction of the directivity of the sound outputted from each of the parametric speakers 5 (#1), (#2), and (#3) is also referred to as a sound-emitted direction of each of the parametric speakers 5.

The current sound-emitted direction of each of the parametric speakers 5 is acquired, for example, in the following manner. Correspondence information between the standard attitude (direction) of the mobile phone device 1 and the sound-emitted directions (X direction, Y direction and Z direction) of each of the parametric speakers 5 is retained in advance. The selecting unit 4 reflects a difference between the current attitude and the standard attitude of the mobile phone device 1 to the sound-emitted direction of each of the parametric speakers 5 on the basis of this correspondence information and the attitude information transmitted from the signal processing unit 3, thereby calculating the sound-emitted direction of each of the parametric speakers 5 (#1), (#2), and (#3).

Next, the selecting unit 4 judges whether there exists any parametric speaker 5 that outputs a sound having the directivity whose direction falls within a predetermined range of angles relative to a predetermined direction, from among the plural parametric speakers 5. In the case where such a parametric speaker 5 exists, the selecting unit 4 selects at least one parametric speaker 5 that outputs a sound having the directivity whose direction falls within the predetermined range of angles relative to the predetermined direction, and causes only the selected parametric speaker 5 to output the predetermined notification sound. On the other hand, in the case where such a parametric speaker 5 does not exist, the selecting unit 4 activates the vibrator 8.

Information on the predetermined direction and the predetermined range of angles is retained in advance so as to be able to be adjusted. The predetermined direction is set, for example, to the X direction shown in FIG. 2. The predetermined range of angles indicates the range of selection for the incoming-call notification, and may be determined on the basis of the range of directivities of the parametric speakers 5. Further, the predetermined range of angles may be set to 0 (zero). In this exemplary embodiment, there is no limitation on the predetermined direction and the predetermined range of angles. Further, it may be possible to employ a configuration in which a user changes setting of the predetermined direction and the predetermined range of angles, for example, through a user interface screen.

Further, in the case where there are plural parametric speakers 5 that satisfy the condition described above, the selecting unit 4 may select a parametric speaker 5 that outputs a sound having directivity whose direction is the nearest to the predetermined direction, or may select all the corresponding parametric speakers 5. In the latter case, the selected parametric speakers 5 output the notification sounds.

### [Example of Operation]

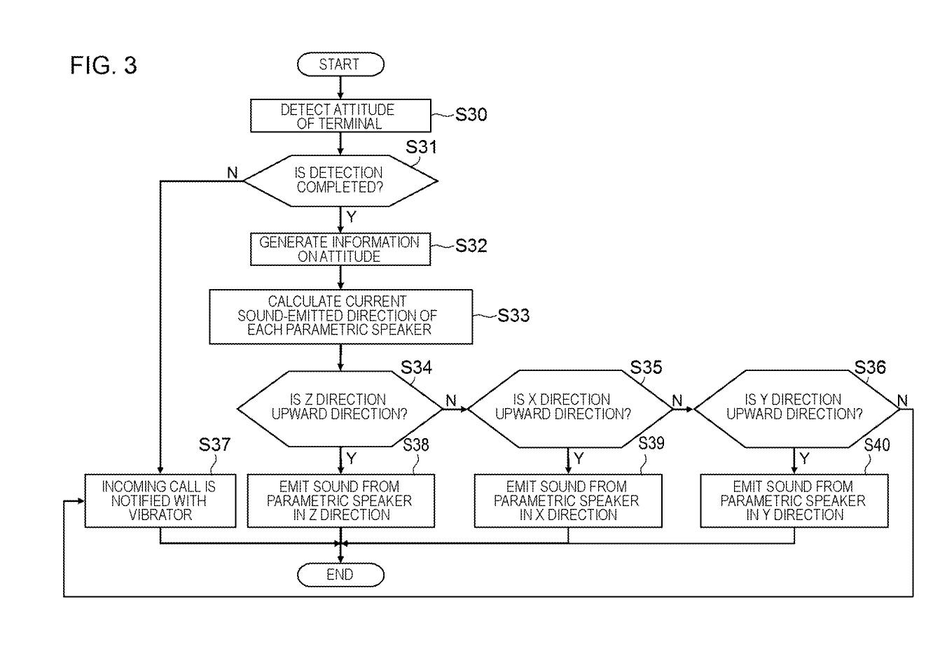

FIG. 3 is a flowchart showing an example of operations performed by the mobile phone device 1 according to this exemplary embodiment. Upon receiving an incoming mail or incoming call, the mobile phone device 1 operates in the following manner. In the example illustrated in FIG. 3, an example in which the predetermined direction is set to the upward direction is used.

The sensor 2 detects the attitude (orientation) of the mobile phone device 1 (S30).

The signal processing unit 3 analyzes the detected signal from the sensor 2, and judges whether the attitude of the mobile phone device 1 can be successfully detected (S31). Note that this judgment may be made by the sensor 2. If the attitude of the mobile phone device 1 is successfully detected (S31; Y), the signal processing unit 3 generates attitude information on the mobile phone device 1 (S32). On the other hand, if the attitude of the mobile phone device 1 is not successfully detected (S31; N), the selecting unit 4 vibrates the vibrator 8 for the incoming-call notification (S36).

The selecting unit 4 calculates the current sound-emitted direction of each of the parametric speakers 5 (#1), (#2), and (#3) on the basis of the attitude information from the signal processing unit 3 (S33).

The selecting unit 4 judges whether the sound-emitted direction (Z direction in FIG. 2) of the parametric speaker 5 (#1) falls within the predetermined range of angles relative to the upward direction (S34). If the Z direction falls within the predetermined range of angles relative to the upward direction (S34; Y), the selecting unit 4 selects the parametric speaker 5 (#1), and causes only this parametric speaker 5 (#1) to output the predetermined notification sound (S38).

If the Z direction falls outside the predetermined range of angles (S34; N), the selecting unit 4 judges whether the sound-emitted direction (X direction in FIG. 2) of the parametric speaker 5 (#2) falls within the predetermined range of angles relative to the upward direction (S35). If the X direction falls within the predetermined range of angles relative to the upward direction (S35; Y), the selecting unit 4 selects the parametric speaker 5 (#2), and causes only this parametric speaker 5 (#2) to output the predetermined notification sound (S39).

If the Z direction and the X direction fall outside the predetermined range of angles (S34; N and S35; N), the selecting unit 4 judges whether the sound-emitted direction (Y direction in FIG. 2) of the parametric speaker 5 (#3) falls within the predetermined range of angles relative to the upward direction (S36). If the Y direction falls within the predetermined range of angles relative to the upward direction (S36; Y), the selecting unit 4 selects the parametric speaker 5 (#3), and causes only this parametric speaker 5 (#3) to output the predetermined notification sound (S40).

If the Z direction, the X direction, and the Y direction fall outside the predetermined range of angles (S34; N, S35; N, and S36; N), the selecting unit 4 vibrates the vibrator 8 for the incoming-call notification (S37).

### [Operation and Effect]

In this exemplary embodiment, the attitude of the mobile phone device 1 is detected, the sound-emitted direction of each of the parametric speakers 5 is calculated according to the detected attitude of the mobile phone device 1, and the predetermined notification sound is outputted only from the parametric speaker 5 that outputs a sound having directivity whose direction (sound-emitted direction) falls within the predetermined range of angles relative to the predetermined direction.

Thus, according to this exemplary embodiment, it is possible to emit the notification sound only within the predetermined range of angles relative to the predetermined direction. Thus, for example, in the case where the predetermined direction is set to the upward direction or downward direction, it is possible to reduce the possibility that the notification sound is heard by other people. This makes it possible to prevent other people from feeling unpleasantness caused by the notification sound. Further, it is possible to reliably make the user recognize the notification sound by setting the predetermined direction to a direction in which the user of the mobile phone device 1 is located. In other words, according to this exemplary embodiment, even if the parametric speaker 5 is used for outputting the sound, it is possible to avoid a situation where the notification sound is outputted in a direction completely different from the user, so that the user is not aware of the notification sound.

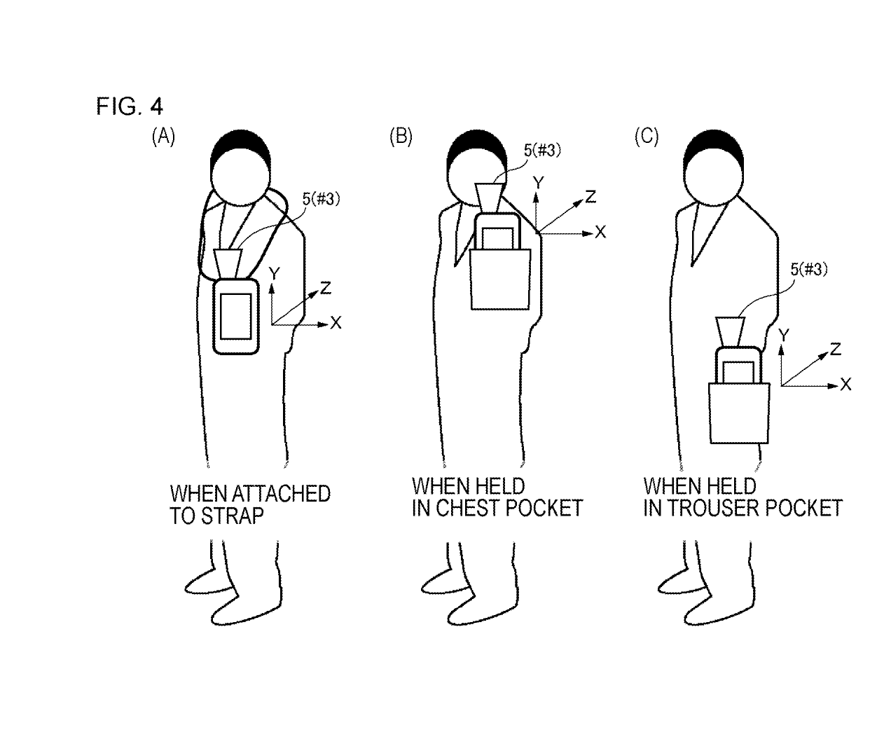

FIG. 4 to FIG. 6 illustrate examples of usage modes of the mobile phone device 1 according to this exemplary embodiment.

FIG. 4 illustrates a case (FIG. 4(a)) in which the mobile phone device 1 is carried with a neck strap, a case (FIG. 4(b)) in which the mobile phone device 1 is held in a chest pocket, and a case (FIG. 4(c)) in which the mobile phone device 1 is held in a trouser pocket. In the case where the predetermined direction is set to the upward direction in the usage modes as illustrated in FIG. 4, the notification sounds are outputted only from the parametric speaker 5 (#3) (only toward the Y direction). Thus, the user can easily hear the notification sounds and the notification sounds are less likely to annoy other people.

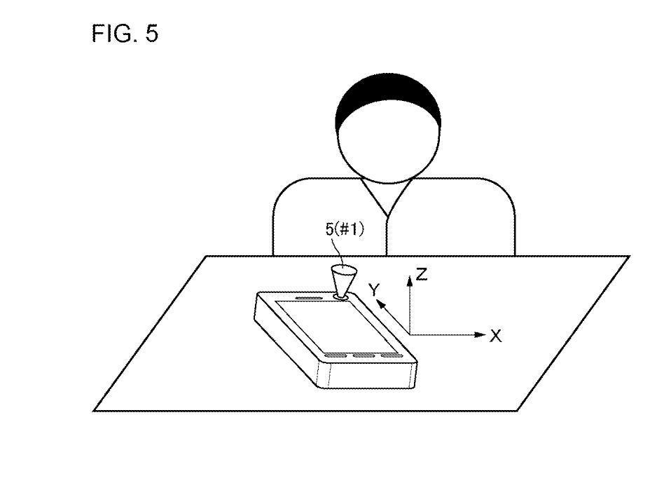

FIG. 5 illustrates a case where the mobile phone device 1 is placed, for example, on a desk. In the case where the predetermined direction is set to the upward direction in the usage mode illustrated in FIG. 5, the notification sounds are outputted only from the parametric speaker 5 (#1) (only toward the X direction). Thus, the user can easily hear the notification sounds, and the notification sounds are less likely to annoy other people.

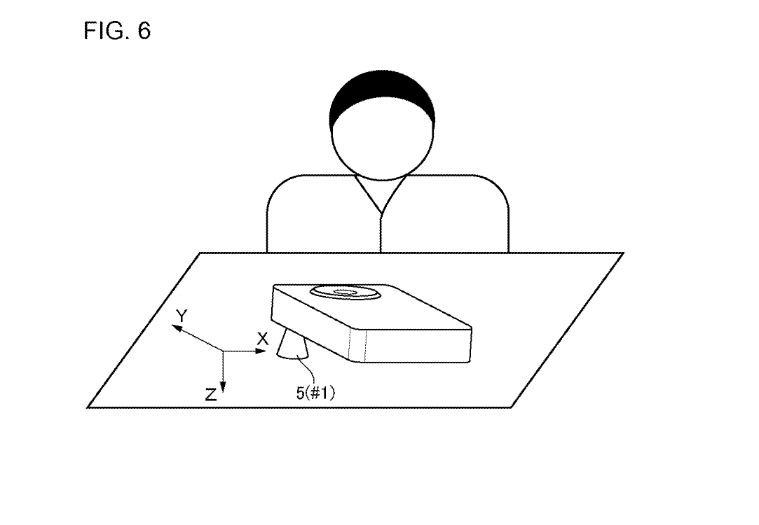

FIG. 6 illustrates another mode of a case where the mobile phone device 1 is placed, for example, on a desk. In FIG. 6, the sound-emitted direction (Z direction) of the parametric speaker 5 (#1) is set to the downward direction, and thus, there exists no parametric speaker 5 that has the sound-emitted direction set to the upward direction. In this case, the incoming-call notification is made with the vibrator 8. This makes it possible to avoid a situation where the sound is emitted toward the direction in which the user is not located, so that the user is not aware of the incoming call.

### Modification Example

In the above-described exemplary embodiment, an example has been given in which the mobile phone device 1 has the vibrator 8 serving as the output unit that outputs the notification mode other than sounds. However, as for the output unit that outputs the notification mode other than sounds, a unit that outputs light such as an LED element may be provided, or a processing unit that outputs other notification modes may be provided.

Further, in the above-described exemplary embodiment, processes performed at the time of incoming-call notification have been given as an example. However, the present invention is not limited to the processes performed at the time of the incoming-call notification. The present invention may be applied not only to incoming-call notification, but also to processes of notification to the user or calling the user. Further, in the above-described exemplary embodiment, the present invention is applied to the mobile phone device 1 as an example. However, there is no limitation to the device to which the present invention is applied, provided that the device is a portable device that has a function of notifying the user or calling the user.

Further, the term “parametric speaker 5” described above only means a speaker (high-directivity speaker) that can output sounds having a sharp directivity in a specific direction, and thus, there is not addition of any other limitations.

It should be noted that, in the flowchart used for descriptions above, plural steps are described in a sequential order. However, the order of the steps performed in this exemplary embodiment is not limited to the order of the steps described. In this exemplary embodiment, the order of the steps illustrated in the drawing may be exchanged, provided that the exchange does not impair the details of the processes.

The present application claims priority based on Japanese Patent Application No. 2011-152616 filed in Japan on Jul. 11, 2011, the disclosures of which are incorporated herein by reference in their entirety.

1. A portable device, comprising:
a plurality of parametric speakers that each output a sound having directivity in an individual specific direction;
an attitude detecting unit that detects an attitude of the portable device; and
a selecting unit that selects, from among the plurality of parametric speakers, a parametric speaker that outputs a sound having directivity whose direction falls within a predetermined range of an angle relative to a predetermined direction, on the basis of information on the attitude detected by the attitude detecting unit, and causes only the selected parametric speaker to output a predetermined notification sound.

2. The portable device according to claim 1, wherein
the selecting unit acquires correspondence information between a direction of the directivity of the outputted sound of each of the parametric speakers and a standard attitude of the portable device, calculates a current direction of the directivity of the outputted sound of each of the parametric speakers on the basis of this correspondence information and the information on the attitude detected by the attitude detecting unit, and selects the parametric speaker using the result of calculation.

3. The portable device according to claim 1, further comprising:
an output unit that outputs a notification mode other than the sound, wherein
the selecting unit causes the output unit to output in the case where there exists no parametric speaker that outputs a sound having directivity whose direction falls within the predetermined range of the angle relative to the predetermined direction.

4. The portable device according to claim 3, wherein
the output unit outputs vibration or light as the notification mode other than the sound.

5. A method of outputting a notification sound performed by a portable device including a plurality of parametric speakers that each output a sound having directivity in an individual specific direction, the method including:
detecting an attitude of the portable device;
selecting, from among the plurality of parametric speakers, a parametric speaker that outputs a sound having directivity whose direction falls within a predetermined range of an angle relative to a predetermined direction on the basis of information on the detected attitude; and
causing only the selected parametric speaker to output a predetermined notification sound.

6. A non-transitory computer-readable storage medium storing a program performed by a portable device including a plurality of parametric speakers that each output a sound having directivity in an individual specific direction, the program causing the portable device to perform the following:
detecting an attitude of the portable device;
selecting, from among the plurality of parametric speakers, a parametric speaker that outputs a sound having directivity whose direction falls within a predetermined range of an angle relative to a predetermined direction on the basis of information on the detected attitude; and
causing only the selected parametric speaker to output a predetermined notification sound.

7. The method according to claim 5, further including:
acquiring correspondence information between a direction of the directivity of the outputted sound of each of the parametric speakers and a standard attitude of the portable device; and
calculating a current direction of the directivity of the outputted sound of each of the parametric speakers on the basis of this correspondence information and the information on the detected attitude, wherein
the selecting the parametric speaker uses the result of calculation.

8. The method according to claim 5, further including
causing an output unit to output a notification mode other than the sound in the case where there exists no parametric speaker that outputs a sound having directivity whose direction falls within the predetermined range of the angle relative to the predetermined direction.

9. The method according to claim 8, wherein
the output unit outputs vibration or light as the notification mode other than the sound.

10. The non-transitory computer-readable storage medium according to claim 6, the program causing the portable device to further perform:
acquiring correspondence information between a direction of the directivity of the outputted sound of each of the parametric speakers and a standard attitude of the portable device; and
calculating a current direction of the directivity of the outputted sound of each of the parametric speakers on the basis of this correspondence information and the information on the detected attitude, wherein
the selecting the parametric speaker uses the result of calculation.

11. The non-transitory computer-readable storage medium according to claim 6, the program causing the portable device to further perform
causing an output unit to output a notification mode other than the sound in the case where there exists no parametric speaker that outputs a sound having directivity whose direction falls within the predetermined range of the angle relative to the predetermined direction.

12. The non-transitory computer-readable storage medium according to claim 11, wherein the output unit outputs vibration or light as the notification mode other than the sound.
